(19) United States
(12) Patent Application Publication
(10) Pub. No.: US 2010/0077486 A1
(43) Pub. Date: Mar. 25, 2010

(54) METHOD AND APPARATUS FOR DIGITAL CONTENT MANAGEMENT

(75) Inventors: Jin Qu, Shanghai (CN); Fulong Ma, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,197

(22) PCT Filed: Dec. 23, 2005
(86) PCT No.: PCT/IB05/54390

§ 371 Date: Dec. 7, 2009

(30) Foreign Application Priority Data
Dec. 28, 2004 (CN) 200410104502.5

(51) Int. Cl. H04L 9/32

(52) U.S. Cl. 726/28

(57) ABSTRACT

The present invention discloses a method for using digital content. According to this method, a user terminal acquires an authorization file at least including a predetermined processing right from the authorization terminal, the predetermined processing right allowing the user terminal to process the digital content in the predetermined manner, e.g. edit the digital content. When the processing right requested by the user is included in the authorization file that the user terminal acquires, the user can perform the predetermined processing on the digital content. This invention also discloses apparatus for using the digital content. The method and apparatus of the present invention can bring better convenience to the user and protect profits of the content provider as well.

### FIELD OF THE INVENTION

The present invention relates generally to DRM (Digital Right Management), and more particularly, to a method and apparatus for using digital content.

### BACKGROUND ART OF THE INVENTION

With rapid development of Internet and digital technologies, it becomes easier to use source digital content. From viewpoints of content providers, unlimited use for the source digital content will cause a great damage to the benefits of the content providers because they want to protect the copyright of their respective contents. On the other hand, from viewpoints of content consumers, they always hope to use the content without any limitation.

In order to balance both interests of the content providers and the consumers, a concept of AD (Authorized Domain) is presented to ensure that the contents are accessed based on an authorization from the content providers. A main idea of AD is to provide a controlled network environment in which the content can be used relatively freely within the boundary of AD. Generally, AD consists of a set of interconnected devices and users, and these devices and users belong to a family. In an AD, users are embodied by related devices (i.e. user devices). In such an AD, the contents can be moved and/or copied freely between user devices, but the contents are restricted to move out terminal the AD. The contents can usually be transferred to the AD via standard distribution channels (e.g. video broadcast, LAN, Internet, telephone line, satellite download and so on) from the content providers. Additionally, the contents can be inputted into the AD via a conventional mail.

Currently, there are various techniques for realizing an AD system, for example, a method and system for constructing AD is described in an international patent application WO03/098931 filed by KONINKLIJKE PHILIPS ELECTRONICS N.V. on Nov. 27, 2003, which is entirely incorporated herein by reference.

In prior arts, content providers prohibit the content consumers to make any alteration to the content. A user can only play, copy and transfer the digital content according to the rule set by the content provider. Thus, if a content consumer may need the same content for different user devices (such as PC and mobile phone), he has to get the digital content in different versions/formats from the content provider, which causes great inconvenience to the content consumer.

### OBJECT AND SUMMARY OF THE INVENTION

An object of the present invention is to provide a method and apparatus for using the digital content, which allows a user terminal to perform a required processing on the digital contents in the case of acquiring authorization from the content providers, and tracks the user terminal that performs the corresponding processing.

According to one embodiment of the present invention, there is provided a method for authorizing use of a digital content, comprising: receiving a request from a user terminal, the request requesting to authorize a processing right to the user terminal, the processing right allowing the user terminal to process the digital content in a predetermined manner; generating an authorization file containing the processing right based on the request, to be sent to the user terminal, so that the user terminal can process the digital content in the predetermined manner.

Preferably, verifying whether said request derives from a valid user terminal before generating the authorization file. Generating said authorization file after determining that said request derives from a valid user terminal.

Preferably, transmitting said authorization file to said user terminal after generating the authorization file.

More preferably, transmitting said authorization file and the digital content to said user terminal after generating the authorization file.

Preferably, said request further comprises ID of user terminal. Said ID of the user terminal includes one of the following ID information: user ID, device ID and AD ID.

Preferably, said predetermined manner includes at least one of the following processing manners: transcoding the digital content, editing the digital content, and extracting some content from the digital content.

According to another embodiment of the present invention, there is provided a method for requesting to authorize a user terminal to use a digital content, comprising: transmitting a request, the request requesting to authorize a processing right to the user terminal, the processing right allowing the user terminal to process the digital content in a predetermined manner; and then, receiving an authorization file containing the processing right from the authorizing terminal, so that the user terminal can process the digital content in the predetermined manner.

According to yet another embodiment of the present invention, there is provided a method for processing a digital content in a user terminal, comprising: (a) receiving a request, the request requesting to process the digital content in a predetermined manner; (b) verifying whether the user terminal is authorized to process the digital content in the predetermined manner; and (c) processing the digital content in the predetermined manner to acquire a processed digital content when the user terminal is authorized to process the digital content in the predetermined manner.

Preferably, said step (b) comprises: (i) acquiring an authorization file corresponding to the digital content; and (ii) checking whether a processing right is included in the authorization file. The processing right authorizes the user terminal to process the digital content in the predetermined manner.

Preferably, the method further comprises: associating related processing information with said processed digital content. Said processing information includes at least one of the following information: said authorization file information, processing manner, processing time, condition of the digital content before processing, and ID of the user terminal.

According to still another embodiment of the present invention, there is provided a method for operating a processed digital content in a user terminal, comprising: receiving a request, the request requesting to operate the processed digital content; verifying whether the processed digital content is obtained according to a processing in an authorized manner; and obtaining the processed digital content for the user terminal to be operated when the processed digital content is obtained according to the processing in the authorized manner.

According to another embodiment of the present invention, there is provided an apparatus for authorizing use of a digital content, comprising: authorization request receiving means for receiving a request from a user terminal, the request requesting to authorize a processing right to the user terminal, the processing right allowing the user terminal to process the digital content in a predetermined manner; and generating means for generating an authorization file containing the processing right based on the request, to be sent to the user terminal, so that the user terminal can process the digital content in a predetermined manner.

Preferably, the apparatus further comprises transmitting mean for transmitting said authorization file to said user terminal. Said transmitting means is also used to send said digital content to said user terminal.

The apparatus further comprises validity verifying means for verifying whether said request derives from a valid user terminal.

According to another embodiment of the present invention, there is provided an apparatus for requesting to authorize a user terminal to use a digital content, comprising: transmitting means for transmitting a request, the request requesting to authorize a processing right to the user terminal, the processing right allowing the user terminal to process the digital content in a predetermined manner; and authorization receiving means for receiving an authorization file containing the processing right from the authorizing terminal so that the user terminal can process the digital content in the predetermined manner.

According to yet another embodiment of the present invention, there is provided an apparatus for processing a digital content in a user terminal, comprising: processing request receiving means for receiving a request, the request requesting to process the digital content in a predetermined manner; authorization verifying means for verifying whether the user terminal is authorized to process the digital content in the predetermined manner; and processing means for processing the digital content in the predetermined manner to acquire a processed digital content when the user terminal is authorized to process the digital content in the predetermined manner.

Preferably, said authorization verifying means comprises: acquiring means for acquiring an authorization file corresponding to the digital content; and checking means for checking whether a processing right is included in the authorization file, the processing right authorizing the user terminal to process the digital content in the predetermined manner.

Preferably, the apparatus further comprises: associating means for associating related processing information with said processed digital content.

According to still another embodiment of the present invention, an apparatus for operating a processed digital content in a user terminal, comprising: operating request receiving means for receiving a request, the request requesting to operate the processed digital content; processing verifying means for verifying whether the processed digital content is obtained according to a processing in an authorized manner; and operating means for obtaining the processed digital content for the user to be operated when the processed digital content is obtained according to the processing in the authorized manner.

According to the present invention, the content consumer can not only copy the digital content obtained from the content provider, but also perform processing directly on the obtained content in more manners, so as to be adapted to different practical requirements, for example, transcoding the digital content to be adapted to mobile devices; extracting some needed content from the source digital content; editing the digital content and so on. Therefore, greater convenience can be provided to the user.

Further, in the present invention, the processing on the digital content should acquire authorization from the content provider and it can be seen from the processed digital content who perform corresponding processing on the source digital content, i.e. it can track the user who performs the processing. Thus, the interest of the content provider can be protected effectively.

### BRIEF DESCRIPTION OF THE DRAWINGS

Other objects, features and effects of the invention will become apparent from the following description with reference to the accompanying drawings, in which:

FIG. 1 is a simplified diagram showing the digital content management system according to the present invention;

FIG. 2 is a block diagram showing the detailed configuration of the digital content management system according to one embodiment of the present invention;

FIG. 3 is a block diagram showing the authorization verifying means according to one embodiment of the present invention;

FIG. 4 is a flowchart showing the processing performed in the content provider server according to one embodiment of the present invention;

FIG. 5 is a flowchart showing the processing performed in the authorization file acquiring means of a user device according to one embodiment of the present invention;

FIG. 6 is a flowchart showing the processing performed in the content processing means of the user device according to one embodiment of the present invention; and

FIG. 7 is a flowchart showing the processing performed in another user device according to an embodiment of the present invention.

### DETAILED DESCRIPTION OF THE INVENTION

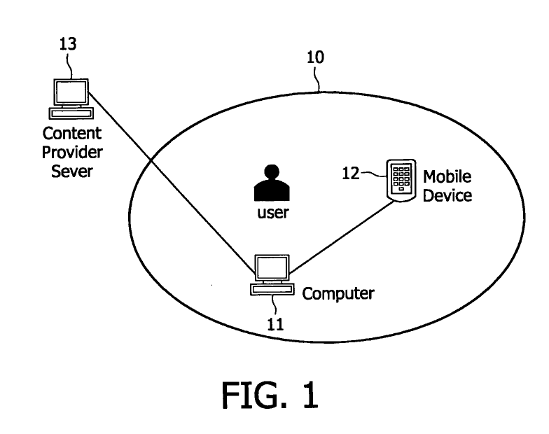

Now, the basic configuration of the digital content management system according to one embodiment of the present invention will be described below with reference to FIG. 1.

FIG. 1 is a simplified diagram showing the digital content management system according to one embodiment of the present invention. In FIG. 1, AD 10 at least comprises user devices 11 and 12. In this embodiment, the user device 11 is a desktop computer, and the user device 12 is a mobile phone. The user device 11 in AD 10 is connected to a content provider server 13 via LAN, Internet, telephone line, mobile communication, or satellite download line, etc., and acquires the required digital content from the content provider server 13. Meanwhile, the user device 12 is connected with the user device 11 in a corresponding communication manner based on types of specific devices, to acquire the required digital content from the user device 11 after being processed by the user device 11. It would be understood by one person skilled in the art that the present invention is limited herein, and the user devices 11 and 12 can also be a notebook computer, PDA, MP3 player or other electronic devices. Further, the user device 11 can acquire the required digital content from content provider server 13 in conventional transferring way, such as a mail, a prestored medium and so on. The digital content usually includes music, song, movie, TV program, picture, text, interactive traffic and etc.

In AD 10, the digital content can flow freely between the user devices 11 and 12 according to a predefined rule, but be restricted to move outside AD 10. Generally, the above function of AD is controlled through a so-called AD-DRM (Authorized Domain-Digital Right Management) system, which is used for implementing content delivery between the content provider and AD.

The specific configuration of AD-DRM system is known to one person skilled in the art, thus no description will be given to it herein. In the present invention, the user device 11 in AD 10 can acquire a predetermined processing right from the content provider server 13 as required, so that the user terminal can perform the predetermined processing required on the digital content. The predetermined processing is an alteration to the integrity of the digital content, for example, transcoding the digital content, editing the digital content and etc. The predetermined processing right is one of authorized rights to the user. Another of authorized rights to the user can be a operating right, which indicates use of the digital content in the case of maintaining the integrity of the digital content, such as play, copy and so on. The detailed description to the AD-DRM system can be referred to DRM for Connected Planet and Connected Home, written by Frank Kamperman, Paul Koster, Geert-Jan, Schrijen, and Bas van den Heuvel. Additionally, reference can go to the international application WO03098931 filed by the same applicant as the present application, on Nov. 27, 2003.

Explanation is given below to some definitions in AD involved in the present invention.

1. Content Container

In order to avoid unauthorized access during storage and transmission, the content is encapsulated in a secure content container. As shown in Table.1, the content container includes the content ID and the content itself. The main purpose of the content container is to offer confidentiality by means of encryption of the content. Meanwhile, the Content ID associates content with the content right, the user right and etc.

TABLE 1
Content container
Content ID
Content

2. Content Right

As shown in Table.2, the content right usually includes content ID, user terminal ID, content provider ID, content key, user authorization information, signature and etc.

Content ID generally refers to ID of the digital content for determining the specific digital content in use. The user terminal ID generally refers to ID of the user terminal that has some rights and has issued an authorization request, to determine a specific user terminal. It may include user ID, device ID or AD ID. Content key refers to the keys for decrypting the encrypted digital content. In a general DRM system, a corresponding key for decrypting the file will be generated during the encryption of the distributed and sold digital content. User right authority indicates the use rights that can be determined based on the agreement or contract between the user terminal and the content provider. In the present invention, the above use rights include operating right and processing right.

TABLE 2
Content rights
Content ID
User terminal ID
Content provider ID
Content keys
User right authority
Signature algorithm
Signature value

3. User Right

User right includes user terminal ID, content ID, content provider ID, right expression, and digital signature. A user right is a certificate that indicates whether a user is allowed to use the content right to access a piece of content. The content ID associates the user right with the content, and the content right.

TABLE 3
User right

Content ID
User terminal ID
Content Provider ID
Rights Expression
Signature algorithm
Signature

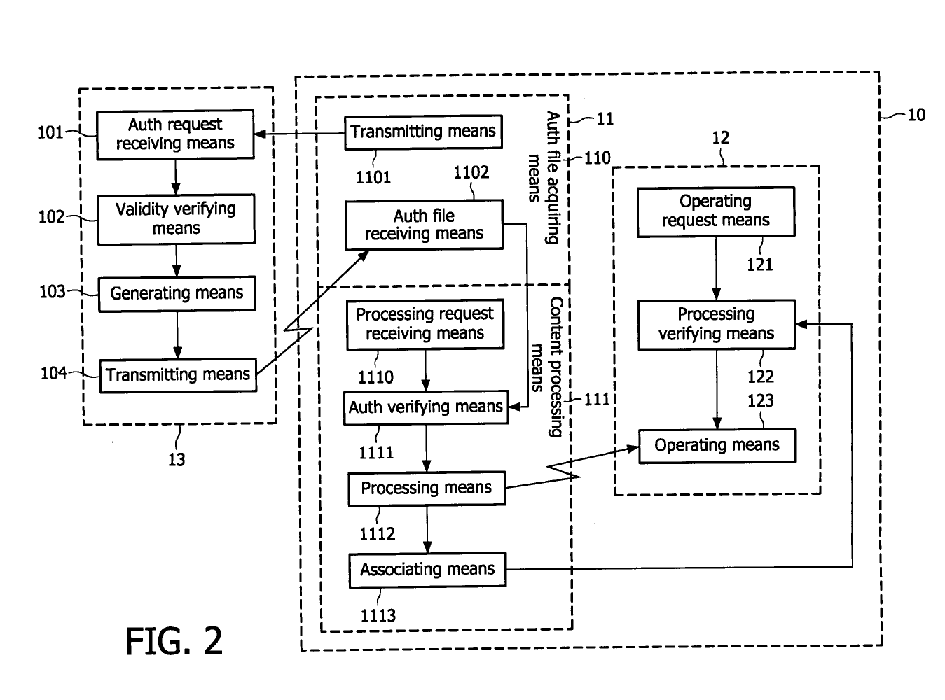

A detailed description will be given now to the digital content management system with reference to FIG. 2. FIG. 2 is a block diagram showing the detailed configuration of the digital content management system according to one embodiment of the present invention.

Referring to FIG. 2, content provider server 13 (content provision terminal, namely authorizing terminal) includes authorization request receiving means 101 and generating means 103.

Authorization request receiving means 101 receives a request from the user device 11 (user terminal). The request at least include user terminal ID, content ID and a predetermined processing right that the user terminal requests. The request can be transferred from the user device 11 to authorization request receiving means 101 of content provider server 13 via Internet, LAN, telephone line, mobile communication network and so on.

If the digital content has already been stored in the user device 11 and the user only wants to acquire a predetermined processing right of the digital content, the user device 11 may only request content provider server 13 to authorize the predetermined processing right to it, so as to process the digital content in user device 11 correspondingly.

Alternatively, if the user wants to obtain a digital content as well as a predetermined processing right of the digital content, the user device 11 may request content provider server 13 to provide the digital content and authorize it a predetermined processing right, so as to perform the required predetermined processing on the digital content.

The request may request to transcode the digital content, for example, convert a high-defined digital content into a low-defined digital content, to be adapted to the requirement of the user device 12 as a mobile phone. The request may also extract some digital content from the source digital content, for example, extract an episode/clip from music as the phone ring. The request may also edit the source digital content, for example, edit personal content based on the digital content. It would be understood that the request is not limited to the above processing manners and can be any processing manner that the user requires.

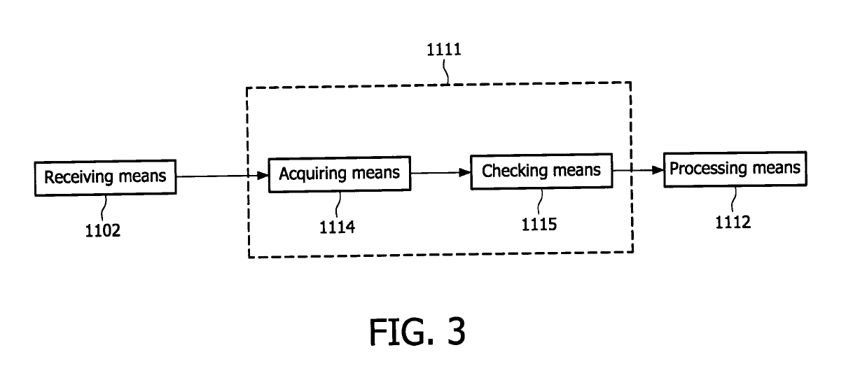

Generating means 103 generates an authorization file containing the predetermined processing right based on the request received by authorization receiving means 103, so as to send it to the user device 11. The predetermined processing right enables the user device 11 to perform the predetermined processing on the digital content. In this embodiment, the authorization file may include content ID, user terminal ID, content provider ID, processing right and so on, as shown in FIG. 3. In this embodiment, generating means 103 may generate the authorization file by means of any general method known by one person skilled in the art. At the same time, the user terminal ID can be user ID, device ID or AD ID.

The generated authorization file is encrypted and signed by means of general encryption tool, and then stored in the storage unit (not given here) of content provider server 13, so as to be sent lately.

Preferably, content provider server 13 according to this embodiment further comprises a validity verifying means 102. After authorization request receiving means 101 receives a processing request from the user device 11, validity verifying means 102 verifies the validity of the user terminal ID, i.e. verifying whether the user terminal is a valid one. After determining the user terminal ID is valid, generating means 103 generates an authorization file based on the request received by authorization request receiving means 101, which can prevent unauthorized access.

Preferably, content provider server 13 according to this embodiment further comprises a transmitting means 104. Preferably, after the generated authorization file is encrypted and signed by means of a general encryption way, transmitting means 104 transmits the encrypted authorization file to the user device 11, wherein the authorization file at least comprises content ID, user terminal ID, ID of the authorizing terminal and the predetermined processing right. In the present invention, transmitting means 104 can transmit the generated authorization file to user device 11 via a communication way known to one person skilled in the art.

In the case where the user terminal requests to transmit the required digital content and requests to authorize a predetermined processing right to it, transmitting means 104 transmits the digital content to the user device 11 along with the authorization file including the corresponding predetermined processing right.

The user device 11 at the user terminal according to this embodiment can be a PC, comprises authorization file acquiring means 110 and content processing means 111, for acquiring the authorization file containing the predetermined processing right from the content provider server 13 and then performing the corresponding predetermined processing on the digital content from the content provider server or the digital content already stored in the user device 11, based on the acquired processing right.

According to this embodiment, authorization file acquiring means 110 comprises transmitting means 1101 and authorization file receiving means 1102.

According to the requirement of the user device, transmitting means 1101 transmits a request for acquiring a processing right to content provider server 13, to acquired a predetermined processing right, so as to perform a corresponding predetermined processing on the digital content already stored in the user device 11.

Alternatively, transmitting means 1101 may transmit a request for acquiring the required digital content from the content provider server 13 and at the same time performing a corresponding predetermined processing on the digital content.

Authorization file receiving means 1102 receives an authorization file generated from content provider server 13. The authorization file includes a predetermined processing right that allows the user device 11 to perform a predetermined processing on the corresponding digital content. The received authorization file can be stored in the storage unit (not given here) of the user device 11.

According to this embodiment, content processing means 111 of the user device 11 includes processing request receiving means 1110, authorization verifying means 1111 and processing means 1112.

Processing request receiving means 1110 receives a processing request from the user, e.g. request for editing the digital content, extracting some digital content from the source digital content and so on. The request may derive from another user device, such as user device 12, or directly from a user input. Authorization verifying means 111 verifies whether user device 11 is authorized to perform the processing requested by the user on the digital content, based on the authorization file received by authorization file receiving means 1102. The authorization file can be an authorization file acquired by authorization file receiving means 1102 beforehand and stored in the storage of the user device 11. Alternatively, the authorization file can also be acquired in real-time by authorization file acquiring means 110 based on the user's request. When the authorization file includes the processing right that the user requests, processing means 1112 decrypts the digital content using the content key in the content right and then performs the corresponding processing on the decrypted digital content, to acquire a processed digital content. The processed digital content is encrypted and signed, and then is stored in the storage unit (not given here) of the user device 11.

In this embodiment, preferably, content processing means 111 may further comprise associating means 1113 for associating related processing information with the processed digital content. The related processing information includes the authorization file information before processing, processing manner, processing time, the condition of the digital content before processing, the user terminal ID and so on. For example, the above authorization file information before processing is content/format of the authorization file. The associated file is stored in the storage unit (not given here) of the user device 11, and can be transmit to other user devices along with the processed digital content.

Alternatively, authorization file acquiring means 110 and content processing means 111 in the user device 11 can also be implemented as a single device.

In this embodiment, the user device 12 may include operating request receiving means 121, processing verifying means 122 and operating means 123. Operating request receiving means 121 receives a operating request from the user. The operating request requests to operate the digital content processed in the user device 11. Processing verifying means 122 verifies whether the processed digital content is obtained according to a processing in a manner authorized by content provider server 13, based on the associated information from associating means 1113. Alternatively, processing verifying means 122 can also contact the content provider server 13 directly, to verify whether the processed digital content is obtained according to a processing in a manner authorized by the content provider server 13. If the processed digital content is obtained according to a processing in a manner authorized by content provider server 13, operating means 123 obtains the processed digital content from user device 11, decodes the processed digital content, and operate it in the user terminal.

Now, the configuration of the authorization verifying means 1111 according to a preferred embodiment of the present invention will be described with reference to FIG. 3. FIG. 3 is a block diagram showing the authorization verifying means according to a preferred embodiment of the present invention. In this embodiment, the authorization verifying means 1111 preferably includes acquiring means 1114 and checking means 1115. Acquiring means 1114 acquires an authorization file corresponding to the digital content from receiving means 1102. Checking means 1115 checks whether the authorization file includes the corresponding processing right that the user requests. When checking means 1115 confirms the corresponding processing right is included in the authorization file, processing means 1112 performs the corresponding processing on the digital content.

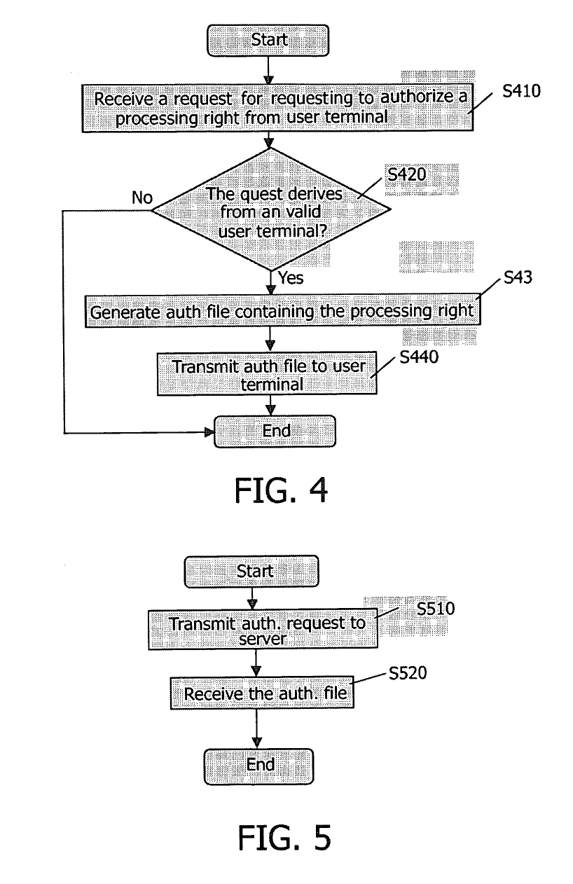

The digital content management method according to the present invention will be described below with reference to FIGS. 4 to 8.

FIG. 4 is a flowchart showing the processing performed in the content provider server 10. First, receiving a request from user device 11, the request at least including the user terminal ID, content ID, and the processing right requested (step S410). In the present invention, the user terminal ID can be user ID, device ID or AD ID. The processing right enable user device 11 to process the digital content in a predetermined manner, for example, requesting to transcode the digital content stored in the user device 11, to be adapted to the requirement of use device 12 as a mobile phone. Then, after receiving the processing request information from user device 11, verifying the validity of the user terminal ID (step S420). If it's determined that user terminal ID is a valid user at step S420, the processing ends.

When it's determined that the user terminal ID is valid, the processing proceeds to step S430. Alternatively, step S420 can be omitted when verification of the user terminal ID is not needed. Then, at step S430, generating means 103 generates an authorization file be means of a known generation method, according to the received request of authorization receiving means 101. In this embodiment, the authorization file includes: content ID, user terminal ID, authorizing terminal ID, processing right, content key and etc. The generated authorization file can be stored in the storage unit of the content provider server 13. Finally, transmitting means 104 transmits the generated authorization file to the user device 11 at step S440 and then the processing ends.

The processing for acquiring the authorization file in user device 11 will be described with reference to FIG. 5.

FIG. 5 is the flowchart showing the processing for acquiring the authorization file in the user device 11. First, according to the requirement of the user device 11, transmitting means 1101 transmits a request to content provider server 13. The request requests to send the required predetermined processing right for performing corresponding processing on the digital content already stored in the user device 11. Or transmitting means 1101 transmit a request that requests to obtain the required digital content and perform the predetermined processing on the digital content (step S510). In the content provider server 13, an authorization file including the processing right will be generated according to the processing of FIG. 4. Then, authorization file receiving means 1102 receives an authorization file including the predetermined processing right generated by content provider server 13 (step S520). The received authorization file is stored in the storage unit (not given) of the user device 11.

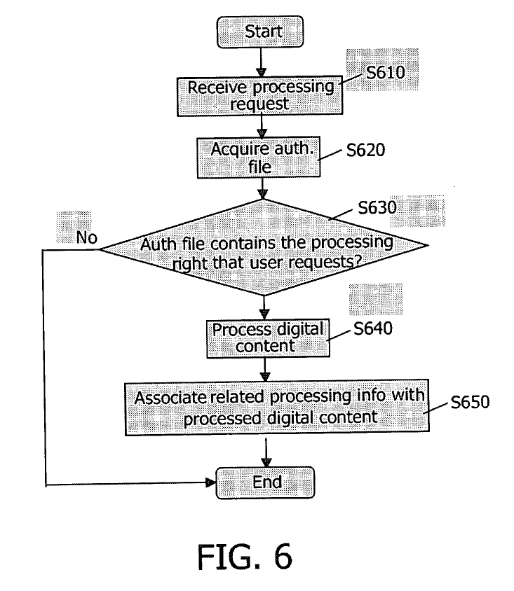

The processing for processing the digital content in the user device 11 will be described with reference to FIG. 6.

FIG. 6 illustrates the flowchart for processing the digital content in the user device 11. First, receiving a processing request from a user, e.g. requesting to edit the digital content, extract new digital content from the source digital content and so on (step S610). Then, acquiring an authorization file corresponding to the digital content from authorization file receiving means 1102 (step S620). Alternatively, the authorization file can be an authorization file acquired and stored beforehand. Then, checking whether the authorization file includes the processing right that the user requires (step S630). When the authorization file doesn't include the processing right the user requires, the processing ends. When the authorization file includes the processing right that the user requires, processing means 1112 encrypts the digital content using the content key in the content right and then performs the processing requested by the user on the encrypted digital content, to acquire a processed digital content (step S640). The processed digital content can be encrypted, signed and then stored in the storage unit of the user device 11. Further, associating related processing information with the processed digital content. Then, associated file is stored in the storage unit (not given here) of the user device 11. Alternatively, step S650 can be omitted in the case that there is no need to track the user processing.

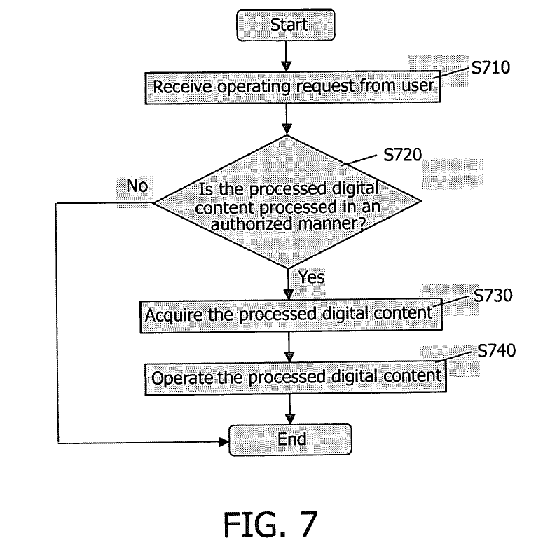

The processing for operating the digital content in the user device 12 will be described with reference to FIG. 7.

FIG. 7 is the flowchart showing the processing for operating the digital content in user device 12. First, receive a operating request from a use. The operating request requests to operate the processed digital content (step S710). Then, according to the correlation information from the user device 11, verifying whether the processed digital content is obtained according to a processing in the manner authorized by the content provider server 13 (step S720), i.e. whether the processing of the digital content in user device 11 gets authorization from the authorizing terminal. Then the associated information can be transmitted to user device 12 along with the digital content, or taken from user device 11 when verification is needed. Alternatively, this step can be performed directly with respect to the content provider server 13.

When the processed digital content is processed in the authorized manner, acquiring the processed digital content from the user device 11 (step S730). Then, decrypting the processed digital content, so as to user to perform required operation on the processed digital content (step S740). Here, the operation refers to use of the digital content without changing the integrity of the digital content, for example, play, copy and etc.

The above embodiments of the present invention are described with reference to AD. However, it would be understood that the present invention is not limited to be used in AD. The present invention is applicable to any application where the user terminal can process the digital content in a predetermined manner through obtaining a processing right from the authorization terminal.

All above-mentioned means illustrated in the flowchart for describing the method is demonstrative. The means having similar functions and structures can be applied to the respective flowchart.

While exemplary embodiments of the invention have been shown and described herein, it will be obvious to those skilled in the art that such embodiments are provided by way of example only. Numerous variations, changes, and substitutions will now be apparent to those skilled in the art. Therefore, all of variations, changes and substitutions shall fall into the scope and spirits of the invention defined by appended claims

1. A method for authorizing use of a digital content, comprising:
(a) receiving a request from a user side, wherein the request requests to authorize a processing right to the user side, and the processing right allows the user side to process the digital content in a predetermined manner; and
(b) generating an authorization file containing the processing right based on the request to be sent to the user side, so that the user side can process the digital content in the predetermined manner.

2. The method according to claim 1, further comprising: transmitting said authorization file to said user side.

3. The method according to claim 1, further comprising: transmitting said digital content to said user side.

4. The method according to claim 1, further comprising: verifying whether said request derives from a valid user side.

5. The method according to claim 1, wherein said request further comprises an ID of a user side.

6. The method according to claim 5, wherein said ID of the user side includes one of the following ID: user ID, device ID and AD ID.

7. The method according to claim 1, wherein said predetermined manner comprises at least one of the flowing processing manners: transcoding the digital content, editing the digital content or extracting some content from the digital content.

8. A method for requesting to authorize a user side to use a digital content, comprising:
(a) transmitting a request, wherein the request requests to authorize a processing right to the user side, and the processing right allows the user side to process the digital content in a predetermined manner;
(b) receiving an authorization file containing the processing right from the authorization side so that the user side can process the digital content in the predetermined manner.

9. The method according to claim 8, wherein said request further includes an ID of a user side.

10. The method according to claim 9, wherein said ID of the user side includes one of the following ID: user ID, device ID and AD ID.

11. The method according to claim 8, wherein said predetermined manner comprises at least one of the flowing processing manners: transcoding the digital content, editing the digital content or extracting some content from the digital content.

12. A method for processing a digital content in a user side, the method comprising:
(a) receiving a request, wherein the request requests to process the digital content in a predetermined manner;
(b) verifying whether the user side is authorized to process the digital content in the predetermined manner; and
(c) processing the digital content in the predetermined manner to acquire a processed digital content when the user side is authorized to process the digital content in the predetermined manner.

13. The method according to claim 12, wherein said step (b) comprising:
(i) acquiring an authorization file corresponding to the digital content;
(ii) checking whether a processing right is included in the authorization file, the processing right authorizing the user side to process the digital content in the predetermined manner.

14. The method according to claim 13, wherein said predetermined manner comprises one of the flowing processing manners: transcoding the digital content, editing the digital content or extracting some content from the digital content.

15. The method according to claim 13, further comprising: associating related processing information with said processed digital content.

16. The method according to claim 15, wherein said processing information includes at least one of the following information: said authorization file information, processing manner, processing time, condition of the digital content before processing, or ID of the user side.

17. A method for operating a processed digital content at a user side, the method comprising:
(a) receiving a request, wherein the request requests to operate the processed digital content;
(b) verifying whether the processed digital content is obtained according to a process in an authorized manner; and
(c) acquiring the processed digital content for the user side to operate when the processed digital content is obtained according the process in the authorized manner.

18. Apparatus for authorizing use of a digital content, comprising:
authorization request receiving means for receiving a request from a user side, wherein the request requests to authorize a processing right to the user side, and the processing right allows the user side to process the digital content in a predetermined manner; and,
generating means for generating an authorization file containing the processing right basing on the request to be sent to the user side, so that the user side can process the digital content in a predetermined manner.

19. The apparatus according to claim 18, further comprising transmitting means for transmitting said authorization file to said user side.

20. The apparatus according to claim 19, wherein said transmitting means is also used for transmitting said digital content to said user side.

21. The apparatus according to claim 18, further comprising validity verifying means for verifying whether said request derives from a valid user side.

22. Apparatus for requesting to authorize a user side to use a digital content, comprising:
transmitting means for transmitting a request, the request requesting to authorize a processing right to the user side, the processing right allowing the user side to process the digital content in a predetermined manner; and
authorization receiving means for receiving an authorization file containing the processing right from the authorization terminal so that the user side can process the digital content in the predetermined manner.

23. Apparatus for processing a digital content in a user side, comprising:
processing request receiving means for receiving a request, wherein the request requests to process the digital content in a predetermined manner;
authorization verifying means for verifying whether the user side is authorized to process the digital content in the predetermined manner; and
processing means for processing the digital content in the predetermined manner to get a processed digital content when the user side is authorized to process the digital content in the predetermined manner.

24. The apparatus according to claim 23, wherein said authorization verifying means includes:
acquiring means for acquiring an authorization file corresponding to the digital content;
checking means for checking whether a processing right is included in the authorization file, wherein the processing right for authorizing the user side to process the digital content in the predetermined manner.

25. The apparatus according to claim 23, further comprising: associating means for associating related processing information with said processed digital content.

26. Apparatus for operating a processed digital content in a user side, comprising:
operating request receiving means for receiving a request, the request requesting to operate the processed digital content;
processing verifying means for verifying whether the processed digital content is obtained according to a process in an authorized manner; and
operating means for obtaining the processed digital content for the user to be operated when the processed digital content is obtained according to the process in the authorized manner.
